(19) United States
(12) Patent Application Publication
(10) Pub. No.: US 2011/0308076 A1
(43) Pub. Date: Dec. 22, 2011

(54) APPARATUS FOR MANUFACTURING LIQUID CRYSTAL DISPLAY PANEL

(76) Inventors: Yeon Heui Nam, Paju-si (KR); Nam Seok Lee, Seoul (KR)

(21) Appl. No.: 13/162,140

(22) Filed: Jun. 16, 2011

(30) Foreign Application Priority Data
Jun. 22, 2010 (KR) 10-2010-0058885

(51) Int. Cl. B23P 19/00

(52) U.S. Cl. 29/822

(57) ABSTRACT

An apparatus for manufacturing a liquid crystal display panel, using a flexible substrate under atmospheric pressure. The apparatus includes a transferring unit for transferring a first substrate in a first direction so as to make the first substrate pass an attaching position for attaching the first substrate to a second substrate; and an attaching unit for attaching the first and second substrates passing the attaching position, wherein the attaching unit includes first and second rotating members respectively connected on one side and the other side of the second substrate so as to provide tension to the second substrate, wherein the first rotating member attaches the first and second substrates passing the attaching position.

### CROSS REFERENCE TO RELATED APPLICATIONS

This application claims the benefit of Korean Patent Application No. 10-2010-0058885 filed on Jun. 22, 2010, which is hereby incorporated by reference as if fully set forth herein.

### BACKGROUND

1. Field of the Invention

The present invention relates to an apparatus for manufacturing a liquid crystal display panel used for a liquid crystal display (LCD) device.

2. Discussion of the Related Art

A liquid crystal display (LCD) device includes a backlight unit and a liquid crystal display panel. The backlight unit provides light to the liquid crystal display panel. The liquid crystal display panel displays predetermined images by the light provided from the backlight unit. The liquid crystal display panel comprises a first substrate with a thin film transistor (TFT) array, a second substrate with a color filter array, and liquid crystal between the first and second substrates. This liquid crystal display panel is manufactured by an attaching process for attaching the first and second substrates to each other by the use of sealant, and a curing process for curing the sealant.

FIG. 1 is a cross section view illustrating a related art apparatus for manufacturing a liquid crystal display panel.

Referring to FIG. 1, the related art apparatus 10 for manufacturing a liquid crystal display panel comprises a chamber 11, a first stage 12, a second stage 13, and a lift 14.

In the chamber 11, an attaching process is carried out by attaching a first substrate 101 with a TFT array and a second substrate 102 with a color filter array to each other. In order to prevent bubbles from occurring in the attaching process of the first and second substrates 101 and 102, the inside of the chamber 11 is maintained under the vacuum condition for the attaching process.

The first substrate 101 is supported by the first stage 12. In more detail, the first substrate 101 on which liquid crystal (L) is formed is supported by the first stage 12.

The second substrate 102 is attached to the second stage 13 by the force of suction. Since sealant (S) is formed on the second substrate 102, the first and second substrates 101 and 102 are attached to each other by the sealant (S).

The lift 14 is connected with the second stage 13. The second stage 13 is lifted up or down by the use of lift 14. When the second stage 13 is lifted down by the lift 14, the second substrate 102 attached to the second stage 13 by the force of suction is also lifted down. According as the second substrate 102 is lifted down together with the second stage 13, the first and second substrates 101 and 102 are attached to each other. After completing the above attaching process, the liquid crystal display panel is transferred to a curing unit (not shown) for curing the sealant (S).

Recently, a liquid crystal display panel using a flexible substrate with flexibility has been actively researched and developed. However, manufacturing the liquid crystal display panel using the flexible substrate and the related art apparatus 10, has the following difficulties.

First, since the related art apparatus 10 has no structure for providing tension to the flexible substrate, the flexible substrate sags during the attaching process, whereby it is difficult to maintain the flexible substrate level without sagging. Accordingly, there is difficulty in manufacturing the liquid crystal display panel using the flexible substrate and the related art apparatus 10. Even though the liquid crystal display panel using the flexible substrate is manufactured using the related art apparatus 10, the liquid crystal display panel has a considerable amount of deterioration in quality.

In the case of the related art apparatus 10 for manufacturing a liquid crystal display panel, the inside of the chamber 11 has to be maintained under a vacuum condition for the attaching process. For this, the structure for providing tension to the flexible substrate is necessarily installed inside the chamber 11 of the apparatus 10 for manufacturing a liquid crystal display panel, whereby the chamber 11 has an increased size. The increased size of the chamber 11 makes it more difficult to maintain the vacuum condition inside the chamber 11, and also causes an increase in unit cost for the liquid crystal display panel by the increased manufacturing cost and the increased material cost.

### SUMMARY

Accordingly, the present invention is directed to an apparatus for manufacturing a liquid crystal display panel that substantially obviates one or more problems due to limitations and disadvantages of the related art.

An aspect of the present invention is to provide an apparatus for manufacturing a liquid crystal display panel, which facilitates to improve quality in a liquid crystal display panel using a flexible substrate, and simultaneously to reduce the unit cost for a liquid crystal display panel using a flexible substrate.

Additional advantages and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these and other advantages and in accordance with the purpose of the invention, as embodied and broadly described herein, there is provided an apparatus for manufacturing a liquid crystal display panel comprising: a transferring unit for transferring a first substrate in a first direction so as to make the first substrate pass an attaching position for attaching the first substrate to a second substrate; and an attaching unit for attaching the first and second substrates passing the attaching position, wherein the attaching unit includes first and second rotating members respectively connected on one side and the other side of the second substrate so as to provide tension to the second substrate, wherein the first rotating member attaches the first and second substrates passing the attaching position.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a cross section view illustrating a related art apparatus for manufacturing a liquid crystal display panel;

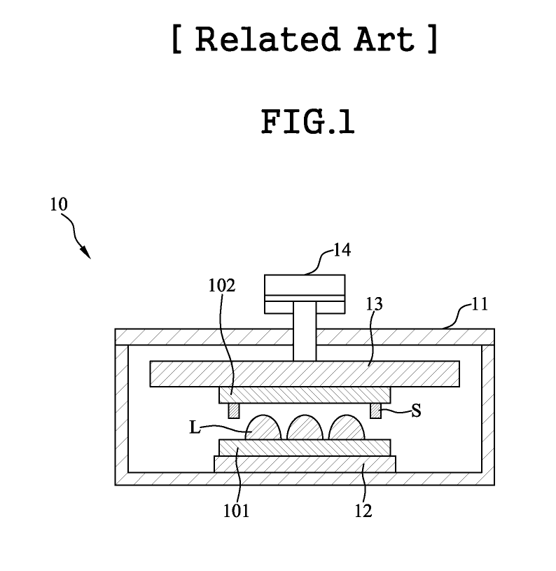

FIG. 2 is a lateral-side view illustrating an apparatus for manufacturing a liquid crystal display panel according to the first embodiment of the present invention;

FIG. 3 is a lateral-side view illustrating an apparatus for manufacturing a liquid crystal display panel according to the second embodiment of the present invention;

FIGS. 4 to 6 are plane views illustrating an operational relation of a first curing unit according to the present invention;

FIG. 7 is a plane view illustrating a first curing unit according to the modified embodiment of the present invention;

FIG. 8 is a lateral-side view illustrating an apparatus for manufacturing a liquid crystal display panel according to the modified embodiment of the present invention; and

FIG. 9 is a plane view illustrating an operational relation of an apparatus for manufacturing a liquid crystal display panel according to the modified embodiment of the present invention.

### DETAILED DESCRIPTION OF THE INVENTION

Reference will now be made in detail to the exemplary embodiments of the present invention, examples of which are illustrated in the accompanying drawings. Wherever possible, the same reference numbers will be used throughout the drawings to refer to the same or like parts.

Hereinafter, an apparatus for manufacturing a liquid crystal display panel according to the present invention will be described with reference to the accompanying drawings.

The apparatus for manufacturing a liquid crystal display panel according to the present invention may have first and second embodiments. The apparatus 1 for manufacturing a liquid crystal display panel according to the first embodiment of the present invention is to carry out an attaching process of first and second substrates, wherein any one of the first and second substrates is flexible. Meanwhile, the apparatus 1 for manufacturing a liquid crystal display panel according to the second embodiment of the present invention is to carry out an attaching process of first and second substrates, wherein any one of the first and second substrates are flexible. Meanwhile, the apparatus 1 for manufacturing a liquid display panel according to the second embodiment of the present invention attaches a first and second substrate in an attaching process. Hereinafter, the first and second embodiments of the present invention will be described in detail as follows.

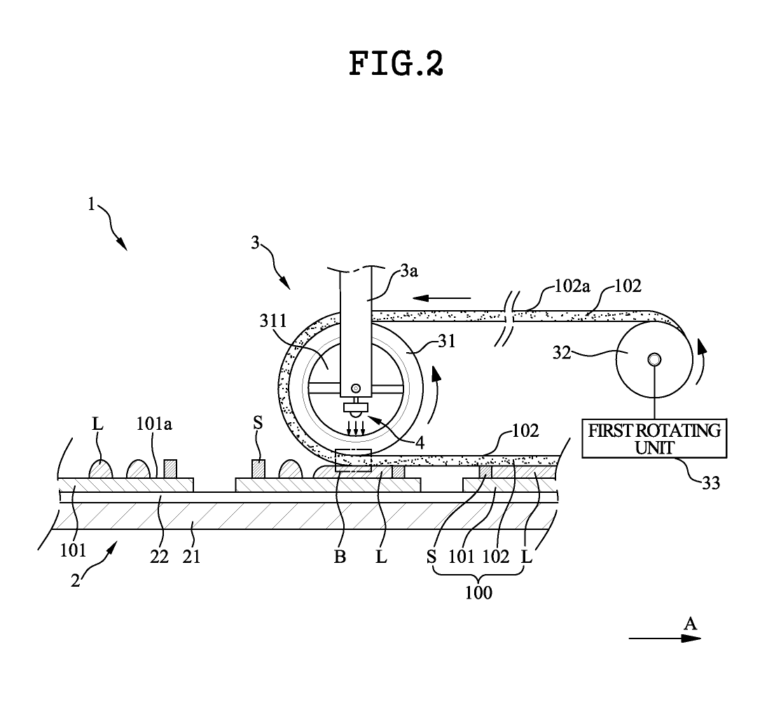

Referring to FIG. 2, the apparatus 1 for manufacturing a liquid crystal display panel according to the first embodiment of the present invention may carry out an attaching process for attaching a first substrate 101 corresponding to a general substrate and a second substrate 102 corresponding to a flexible substrate to each other. The first substrate 101 may be the glass substrate. The apparatus 1 for manufacturing a liquid crystal display panel according to the first embodiment of the present invention may comprise a transferring unit 2 and an attaching unit 3.

The transferring unit 2 transfers the first substrate 101 in a first direction (in the direction of arrow A). The first substrate 101 transferred by the transferring unit 2 passes an attaching position (B). The attaching process for attaching the first and second substrates 101 and 102 to each other is carried out at the attaching position (B). A thin film transistor (TFT) array may be formed on a surface 101a of the first substrate 101, and a color filter array may be formed on a surface 102a of the second substrate 102. The first substrate 101 on which the sealant (A) and liquid crystal (L) are formed may be positioned at the attaching position (B). The transferring unit 2 may include a supporting member 21 and a transferring device 22.

The supporting member 21 supports the first substrate 101. When the first and second substrates 101 and 102 are attached to each other at the attaching position (B), the first and second substrates 101 and 102 may be supported by the supporting member 21.

The transferring device 22 may transfer the first substrate 101 in the first direction (in the direction of arrow A). The transferring device 22 may transfer the first substrate 101 to pass the attaching position (B). The first substrate 101 may be brought into contact with the transferring device 22. Together with the transfer of the transferring device 22, the first substrate 101 may be transferred in the first direction (in the direction of arrow A). The transferring device 22 interposed between the first substrate 101 and the supporting member 21 may be transferred so as to transfer the first substrate 101. The transferring device 22 may be a conveyer belt.

Referring to FIG. 2, the attaching unit 3 may transfer the second substrate 102 to the attaching position (B) so as to attach the first and second substrates 101 and 102 to each other at the attaching position (B). The attaching unit 3 may include a first rotating member 31 and a second rotating member 32.

The first rotating member 31 may attach the first and second substrates 101 and 102 passing the attaching position (B). As the first rotating member 31 applies force to the first and second substrates 101 and 102 passing the attaching position (B), the first and second substrates 101 and 102 are attached to each other. That is, the first and second substrates 101 and 102 are attached to each other by the first rotating member 31 while passing the attaching position (B), and air remaining between the first and second substrates 101 and 102 is eliminated therefrom. Thus, the apparatus 1 for manufacturing a liquid crystal display panel according to the first embodiment of the present invention is capable of attaching the first and second substrates 101 and 102 to each other even under the atmospheric pressure condition, instead of the vacuum condition, without bubbles therebetween. As a result, the apparatus 1 for manufacturing a liquid crystal display panel according to the first embodiment of the present invention reduces the cost for manufacturing the liquid crystal display panel 100 using the flexible substrate, and also improves the quality of the liquid crystal display panel 100 using the flexible substrate.

The first rotating member 31 may be installed in such a manner that it may be positioned above the transferring unit 2. Also, the first rotating member 31 may be installed in such a manner that it may be provided at a predetermined interval from the supporting member 21 at the attaching position (B). The interval between the first rotating member 31 and the supporting member 21 at the attaching position (B) may be determined appropriately for attaching the first and second substrates 101 and 102 passing through a space between the first rotating member 31 and the supporting member 21.

The first rotating member 31 may be rotatably provided in a first frame 3a. As the first rotating member 31 rotates, the second substrate 102 may be transferred to the attaching position (B). The second substrate 102 may be brought into contact with an outer surface of the first rotating member 31. When the first rotating member 31 rotates by the friction applied to the contact surface between the second substrate 102 and the first rotating member 31, the second substrate 102 may be transferred to the attaching position (B). Although not shown, protrusions may be formed on the outer surface of the first rotating member 31. In this case, the second substrate 102 may be transferred to the attaching position (B) when the first rotating member 31 is rotated by the plural protrusions.

One side of the second substrate 102 may be connected with the first rotating member 31. The other side of the second substrate 102 may be connected with the second rotating member 32. As the first and second rotating members 31 and 32 provide predetermined tension to the second substrate 102, the levelly-maintained second substrate 102 may be attached to the first substrate 101 without sagging. As a result, the apparatus 1 for manufacturing a liquid crystal display panel according to the first embodiment of the present invention reduces the cost for manufacturing the liquid crystal display panel 100 using the flexible substrate, and also improves the quality of the liquid crystal display panel 100 using the flexible substrate.

Referring to FIG. 2, the other side of the second substrate 102 may be connected with the second rotating member 32. The second substrate 102 is wound on the second rotating member 32. As the first and second rotating members 31 and 32 rotate, the second substrate 102 may be transferred to the attaching position (B) via the first rotating member 31. The second rotating member 32 may be provided at a predetermined interval from the first rotating member 31.

If the predetermined interval between the first and second rotating members 31 and 32 is considerably large, the attaching unit 3 may further comprise a first connecting unit (not shown) to maintain the second substrate 102 level without sagging. The first connecting unit may be installed between the first rotating member 31 and the second rotating member 32. Also, the first connecting unit may support the second substrate 102 to maintain the second substrate 102 level without sagging. The first connecting unit may rotate together with the rotation of the first and second rotating members 31 and 32. Each of the first rotating member 31, the second rotating member 32 and the first connecting unit may be formed in a cylindrical shape.

The second rotating member 32 may rotate together with the rotation of the first rotating member 31. The first rotating member 31 may be rotated by transferring the first substrate 101 using transferring unit 2. This will be described in detail. While passing the attaching position (B) using transferring unit 2, the first substrate 101 may be attached to the second substrate 102. After passing the attaching position (B), the first substrate 101 attached to the second substrate 102 may be transferred in the first direction (in the direction of arrow A) using of transferring unit 2. Thus, the second substrate 102 together with the first substrate 101 may be continuously transferred in the first direction (in the direction of arrow A). Accordingly, the first rotating member 31 and the second rotating member 32 may be rotated.

Referring to FIG. 2, the attaching unit 3 may further comprise a first rotating unit 33. The first rotating unit 33 may rotate the first or second rotating member 31 or 32 so as to make the second substrate 102 pass the attaching position (B). The first rotating unit 33 may include a motor for providing a rotary power. The motor may be directly connected with a rotation axis of the first or second rotating member 31 or 32. The motor may be connected with the rotation axis of the first or second rotating member 31 or 32 by the use of pulley and belt. The attaching unit 3 may include the plurality of first rotating units 33. In this case, the first and second rotating members 31 and 32 may be respectively rotated by the plurality of first rotating units 33.

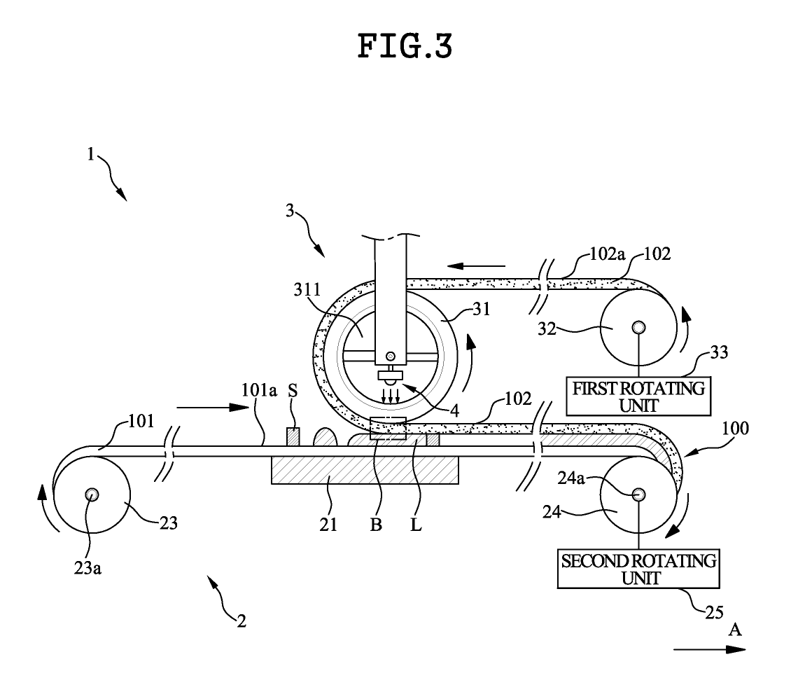

Referring to FIG. 3, the apparatus 1 for manufacturing a liquid crystal display panel according to the second embodiment of the present invention may carry out the attaching process for attaching the first and second substrates 101 and 102, both of which are the flexible substrates. The apparatus 1 for manufacturing a liquid crystal display panel according to the second embodiment of the present invention includes a transferring unit 2 and an attaching unit 3. The attaching unit 3 is the same as the aforementioned one according to the first embodiment of the present invention, whereby a detailed explanation for the attaching unit 3 will be omitted.

The transferring unit 2 may transfer the first substrate 101 in the first direction (in the direction of arrow A). The first substrate 101 transferred by the transferring unit 2 may pass the attaching position (B). The attaching process for attaching the first and second substrates 101 and 102 is carried out at the attaching position (B). A thin film transistor (TFT) array may be formed on a surface 101a of the first substrate 101, and a color filter array may be formed on a surface 102a of the second substrate 102. The first substrate 101 on which the sealant (A) and liquid crystal (L) are formed may be positioned at the attaching position (B). The transferring unit 2 may include a supporting member 21, a first transferring member 23, and a second transferring member 24.

The supporting member 21 may support the first substrate 101. When the first and second substrates 101 and 102 are attached to each other at the attaching position (B), the first and second substrates 101 and 102 may be supported by the supporting member 21.

One side of the first substrate 101 may be connected with the first transferring member 23, and the other side of the first substrate 101 may be connected with the second transferring member 24. As the first and second transferring members 23 and 24 provide predetermined tension to the first substrate 101, the first substrate 101 may be attached to the second substrate 102 while being levelly maintained without sagging. Thus, the apparatus 1 for manufacturing a liquid crystal display panel according to the second embodiment of the present invention reduces the cost for manufacturing the liquid crystal display panel 100 using the flexible substrate, and also improves the quality of the liquid crystal display panel 100 using the flexible substrate.

The first transferring member 23 may be installed in such a manner that it may be positioned at one side of the supporting member 21. The first substrate 101 is wound on the first transferring member 23. As the first and second transferring members 23 and 24 rotate, the first substrate 101 may be transferred from the first transferring member 23 to the second transferring member 24 via the attaching position (B). The first transferring member 23 may rotate on its rotation axis 23a. According to the rotation of the first transferring member 23, the first substrate 101 may be transferred in the first direction (in the direction of arrow A), and may be transferred to the second transferring member 24 via the attaching position (B). The first substrate 101 may be brought into contact with an outer surface of the first transferring member 23. When the first transferring member 23 rotates by the friction applied to the contact surface between the first substrate 101 and the first transferring member 23, the first substrate 101 may be transferred in the first direction (in the direction of arrow A). Although not shown, a plurality of protrusions may be formed on the outer surface of the first transferring member 23. In this case, the first substrate 101 may be transferred in the first direction (in the direction of arrow A) according as the first transferring member 23 rotates by the plurality of protrusions.

Referring to FIG. 3, the other side of the first substrate 101 may be connected with the second transferring member 24. The liquid crystal display panel 100 obtained by the attaching process via the attaching position (B) may be wound on the second transferring member 24. The second transferring member 24 may be positioned at a predetermined interval from the first transferring member 23. The second transferring member 24 may be installed in such a manner that it may be positioned at the other side of the supporting member 21.

If the predetermined interval between the first and second transferring members 23 and 24 is a considerably-large value, the transferring unit 2 may further comprise a second connecting unit (not shown) to maintain the first substrate 101 level without sagging. The second connecting unit may be installed between the first transferring member 23 and the second transferring member 24. The second connecting unit may support the first substrate 101 to maintain the first substrate 101 level without sagging. The second connecting unit may rotate together with the rotation of the first and second transferring members 23 and 24. Each of the first transferring member 23, the second transferring member 24, and the second connecting unit may be formed in a cylindrical shape.

The second transferring member 24 may rotate on its rotation axis 24a. The second transferring member 24 may rotate according to the rotation of the first rotating member 31. This will be described in detail. As the first rotating member 31 rotates by the first rotating unit 33, the second substrate 102 may be attached to the first substrate 101 while passing the attaching position (B). Under the condition that the first and second substrates 101 and 102 are attached to each other, the second substrate 102 may be transferred in the first direction (in the direction of arrow A) by the first rotating unit 33. The first substrate 101 together with the second substrate 102 may be continuously transferred in the first direction (in the direction of arrow A). Thus, the second transferring member 24 may rotate. According to the rotation of the second transferring member 24, the first transferring member 23 may rotate so that the first substrate 101 wound on the first transferring member 23 may be transferred in the first direction (in the direction of arrow A).

Referring to FIG. 3, the transferring unit 2 may further comprise a second rotating unit 25. The second rotating unit 25 may rotate the first or second transferring member 23 or 24 so as to make the first substrate 101 pass the attaching position (B). The second rotating unit 25 may include a motor for providing a rotary power. The motor may be directly connected with the rotation axis 23a, 24a of the first or second transferring member 23 or 24. The motor may be connected with the rotation axis 23a, 24a of the first or second transferring member 23 or 24 by the use of pulley and belt. The transferring unit 2 may include the plurality of second rotating units 25. In this case, the first and second transferring members 23 and 24 may be respectively rotated by the plurality of second rotating units 25.

Referring to FIGS. 2 to 7, the apparatus 1 for manufacturing a liquid crystal display panel according to the present invention may further comprise a first curing unit 4. The first curing unit 4 may be included in both the aforementioned apparatuses 1 according to the first and second embodiments of the present invention.

Referring to FIGS. 2 to 4, the first curing unit 4 may cure sealant (S) between the first and second substrates 101 and 102. The apparatus 1 for manufacturing a liquid crystal display panel according to the present invention may carry out the curing process for curing the sealant (S) as well as the attaching process for attaching the flexible substrate. The apparatus 1 for manufacturing a liquid crystal display panel according to the present invention enables the time gap between the attaching process and the curing process to decrease. Thus, the apparatus 1 for manufacturing a liquid crystal display panel according to the present invention prevents defects caused by the contact between the uncured sealant (S) and liquid crystal (L), to thereby manufacture the liquid crystal display panel 100 with the improved quality. Also, the apparatus 1 for manufacturing a liquid crystal display panel according to the present invention enables an increased manufacture of liquid crystal display panels 100 in a short time by decreasing the time required for the attaching process and curing process.

The first curing unit 4 may be installed in such a manner it may be positioned in an installation hole 311 of the first rotating member 31. That is, the first curing unit 4 may be positioned above the attaching position (B), to thereby cure the sealant (S) between the first and second substrates 101 and 102. Thus, the apparatus 1 for manufacturing a liquid crystal display panel according to the present invention may carry out the curing process almost simultaneously with the attaching process, thereby preventing the defects caused by the contact between the uncured sealant (S) and liquid crystal (L), and decreasing the time required for the attaching process and the curing process. Also, since the first curing unit 4 is provided in the installation hole 311, it is possible to prevent the apparatus 1 from being increased in size by the first curing unit 4. The first rotating member 31 may be formed in a cylindrical shape with a hollow installation hole 311, and the first rotating member 31 may be formed of a material capable of transmitting the light emitted from the first curing unit 4. The first curing unit 4 may be installed in the first frame 3a to thereby prevent the first curing unit 4 from being rotated according to the rotation of the first rotating member 31.

Referring to FIGS. 2 to 4, the first curing unit 4 may include a first light source 41 and a first installing member 42.

The first light source 41 may emit light to cure the sealant (S). The first light source 41 may be an LED lamp emitting UV rays, for example, LED lamp emitting UV rays of 365 nm, 395 nm, or 405 nm wavelength.

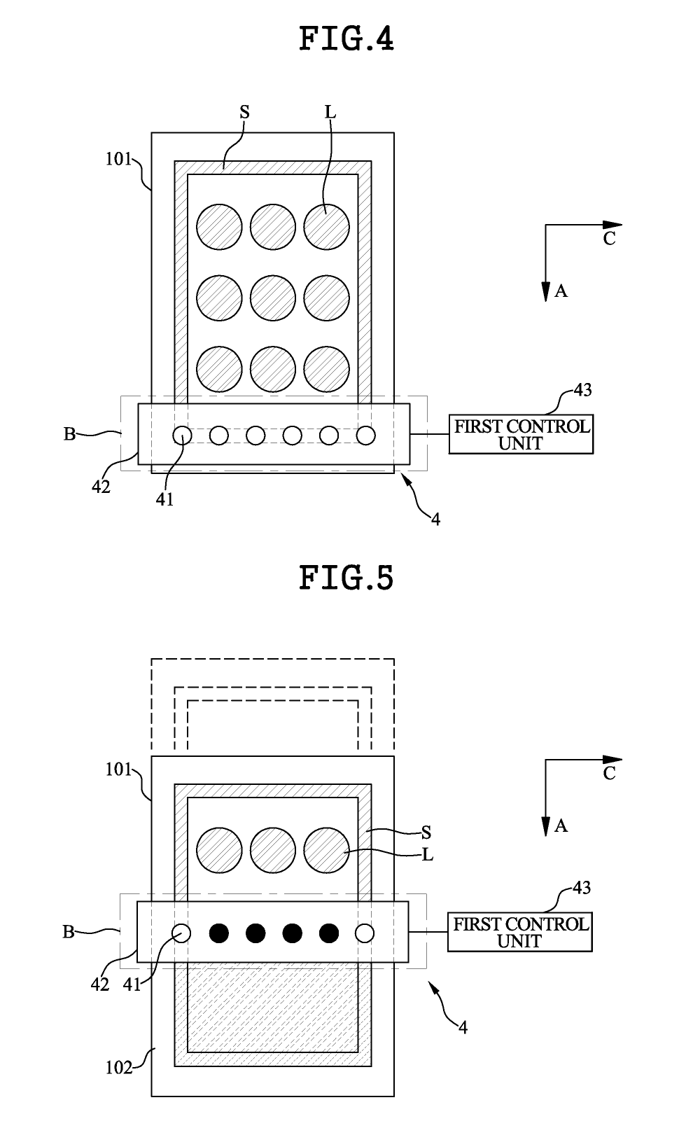

The plurality of first light sources 41 may be provided in the first installing member 42. Accordingly, the first curing unit 4 may provide light sufficient to cure the sealant (S). The plurality of first light sources 41 may be installed in the first installing member 42 in such a manner that they may be arranged in a second direction (in the direction of arrow C, See FIG. 4) perpendicular to the first direction (in the direction of arrow A). The first light sources 41 may be installed in the first installing member 42 in such a manner that they may be provided at fixed intervals along the second direction (in the direction of arrow C). In order to prevent the first installing member 42 from being rotated when the first rotating member 31 is rotated, the first installing member 42 may be installed in the first frame 3a.

Referring to FIGS. 2 to 7, the first curing unit 4 may include a first control unit (43, See FIG. 4).

The first control unit 43 may individually turn on the respective first light sources 41 so as to apply the light to the sealant (S) positioned at the attaching position (B). According to whether or not the first control unit 43 supplies power to the respective first light sources 41, the respective first light sources 41 may be individually turned-on/off under the control of the first control unit 43.

The first control unit 43 may selectively turn on the first light sources 41 according to the shape of the sealant (S) positioned at the attaching position (B). Thus, the apparatus 1 for manufacturing a liquid crystal display panel according to the present invention prevents the light emitted from the first light sources 41 from being applied to the liquid crystal (L), so that it is possible to prevent the liquid crystal (L) from being influenced by the light emitted to cure the sealant (S), to thereby manufacture the liquid crystal panel 100 with the improved quality. This will be described in detail as follows.

As shown in FIG. 4, the sealant (S) may be formed in a square-shaped ring on the first substrate 101. The first substrate 101 with the sealant (S) formed thereon may pass the attaching position (B) while being transferred in the first direction (in the direction of arrow A), and may be attached to the second substrate 102 by the first rotating member 31 while passing the attaching position (B). The first control unit 43 may selectively turn on the first light sources 41 according to the shape of the sealant (S) positioned at the attaching position (B).

First, as shown in FIG. 4, if the portion with only sealant (S) passes the attaching position (B), the first control unit 43 turns on all the first light sources 41. In this case, the second-directional portion (in the direction of arrow C) of the sealant (S) may be positioned at the attaching position (B), and the first control unit 43 may turn on all the first light sources 41 according to the shape of the sealant (S) positioned at the attaching position (B). Although not shown, if the number of first light sources 41 provided in the first installing member 42 exceeds the second-direction portion (in the direction of arrow C) of the sealant (S), the first control unit 43 may selectively turn on some of the first light sources 41 according to the length of the sealant (S) positioned at the attaching position (B). For example, supposing that the relatively small-sized first and second substrates 101 and 102 are provided to the apparatus 1 for manufacturing a liquid crystal display panel according to the present invention. In this case, even though the portion with only sealant (S) passes the attaching position (B), the first control unit 43 may selectively turn on some of the first light sources 41. Thus, the apparatus 1 for manufacturing a liquid crystal panel according to the present invention enables the manufacture of various size liquid crystal display panels 100.

Then, as shown in FIG. 5, if the portion with the sealant (S) and liquid crystal (L) pass the attaching position (B) by the first and second substrates 101 and 102 transferred in the first direction (in the direction of arrow A), the first control unit 43 may turn on some of the first light sources 41. In this case, the liquid crystal (L) portion and the sealant (S) portions may be positioned at the attaching position (B), wherein the sealant (S) portions may be adjacent to the outermost sides of the liquid crystal (L) portion. Thus, the first control unit 43 may turn off the first light sources 41 positioned at the liquid crystal (L) portion, and may selectively turn on the first light sources 41 positioned at the sealant (S) portions. Accordingly, the first curing unit 4 may cure the sealant (S) by applying the light to the sealant (S), and may prevent the liquid crystal (L) from being influenced by the light for curing the sealant (S) by excluding the light from the liquid crystal (L). In FIG. 5, among the first light sources 41, the black-colored first light sources indicate the light sources which are turned-off, and the white-colored first light sources indicate the light sources which are turned-on.

Then, as shown in FIG. 6, if the portion with only sealant (S) passes the attaching position (B) by the first and second substrates 101 and 102 transferred in the first direction (in the direction of arrow A), the first control unit 43 may turn on all the first light sources 41. In this case, the second-directional portion (in the direction of arrow C) of the sealant (S) may be positioned at the attaching position (B), and the first control unit 43 may turn on all the first light sources 41 according to the shape of the sealant (S) positioned at the attaching position (B). Although not shown, if the number of first light sources 41 provided in the first installing member 42 exceeds the second-direction portion (in the direction of arrow C) of the sealant (S), the first control unit 43 may selectively turn on some of the first light sources 41 according to the length of the sealant (S) positioned at the attaching position (B). For example, supposing that the relatively small-sized first and second substrates 101 and 102 are provided to the apparatus 1 for manufacturing a liquid crystal display panel according to the present invention. In this case, even though the portion with only sealant (S) passes the attaching position (B), the first control unit 43 may selectively turn on some of the first light sources 41. Thus, the apparatus 1 for manufacturing a liquid crystal panel according to the present invention enables to manufacture the various size liquid crystal display panels 100.

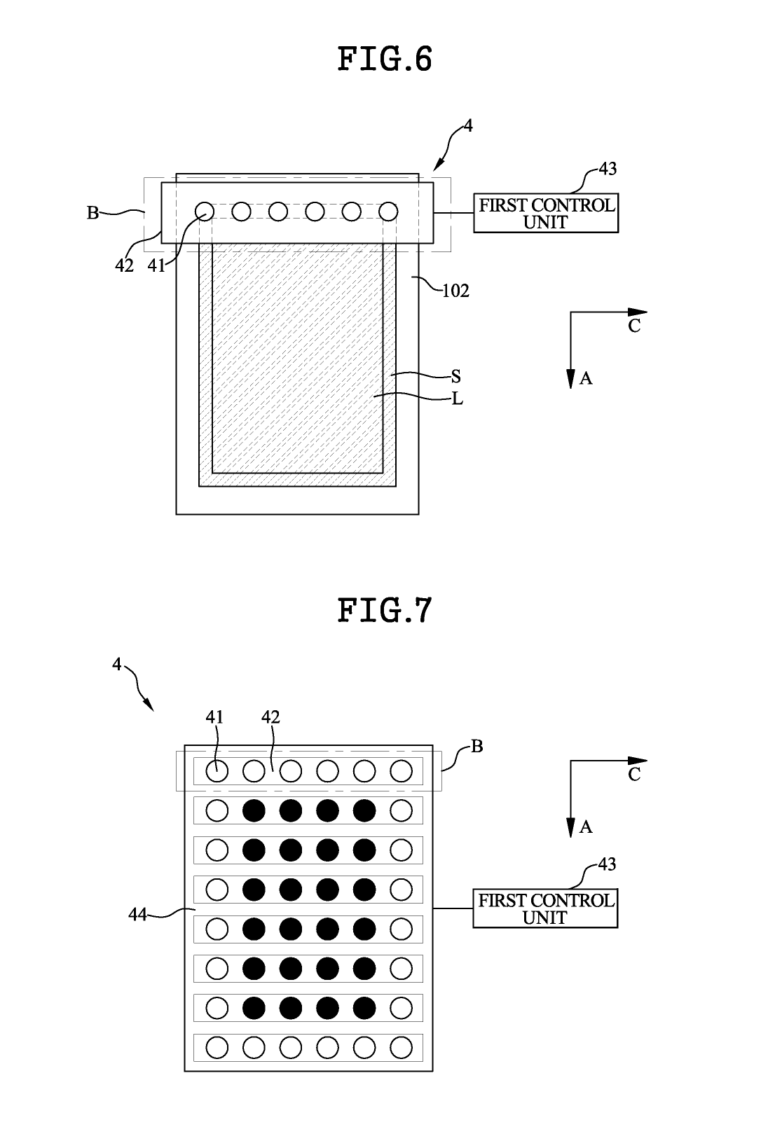

Referring to FIG. 7, the first curing unit 4 according to the modified embodiment of the present invention may further comprise a first connecting member 44.

The plurality of first installing members 42 arranged along the first direction (in the direction of arrow A) may be connected with the first connecting member 44. Thus, the first curing unit 4 may include the plurality of first light sources 41 installed in a matrix configuration. Accordingly, the first curing unit 4 according to the modified embodiment of the present invention may continuously provide the light for curing the sealant (S) to the sealant (S) past the attaching position (B) as well as the sealant (S) positioned at the attaching position (B), to thereby increase the curing time of the sealant (S). In this case, the first control unit 43 may selectively turn on the first light sources 41 according to the shape of the sealant (S), to thereby prevent the light for curing the sealant (S) from being applied to the liquid crystal (L). In FIG. 7, among the first light sources 41, the black-colored first light sources indicate the light sources which are turned-off, and the white-colored first light sources indicate the light sources which are turned-on. In order to prevent the first connecting member 44 from being rotated according to the rotation of the first rotating member 31, the first connecting member 44 may be installed in the first frame 3a.

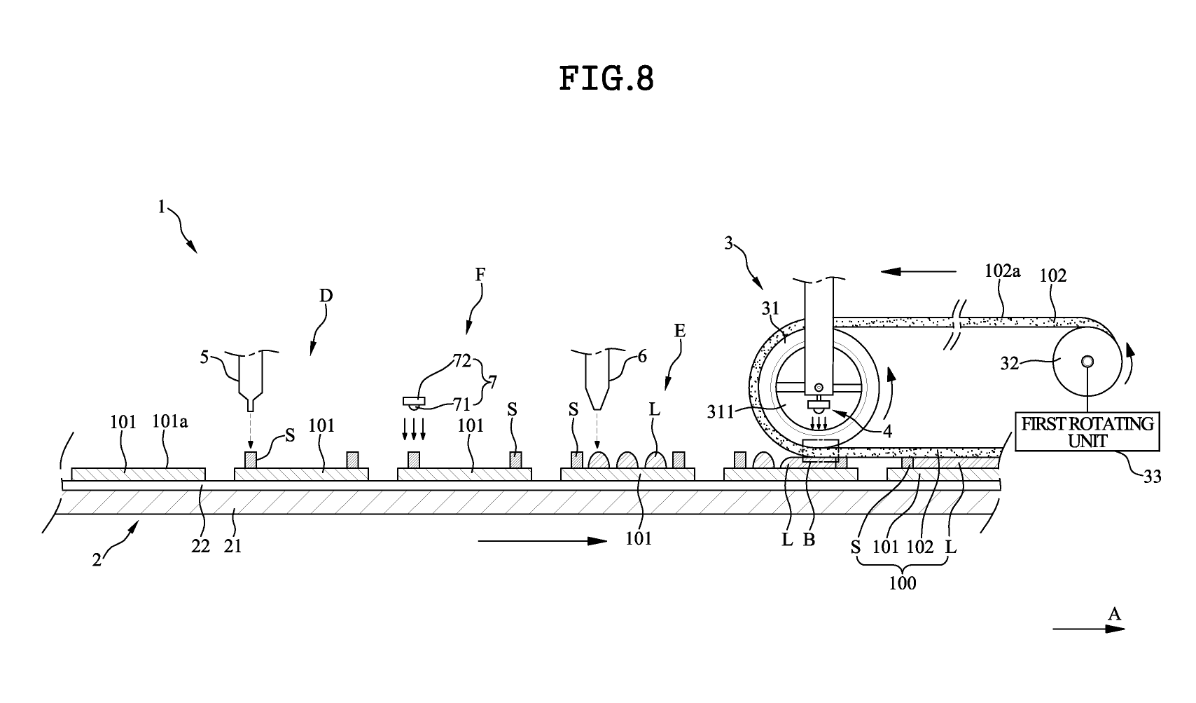

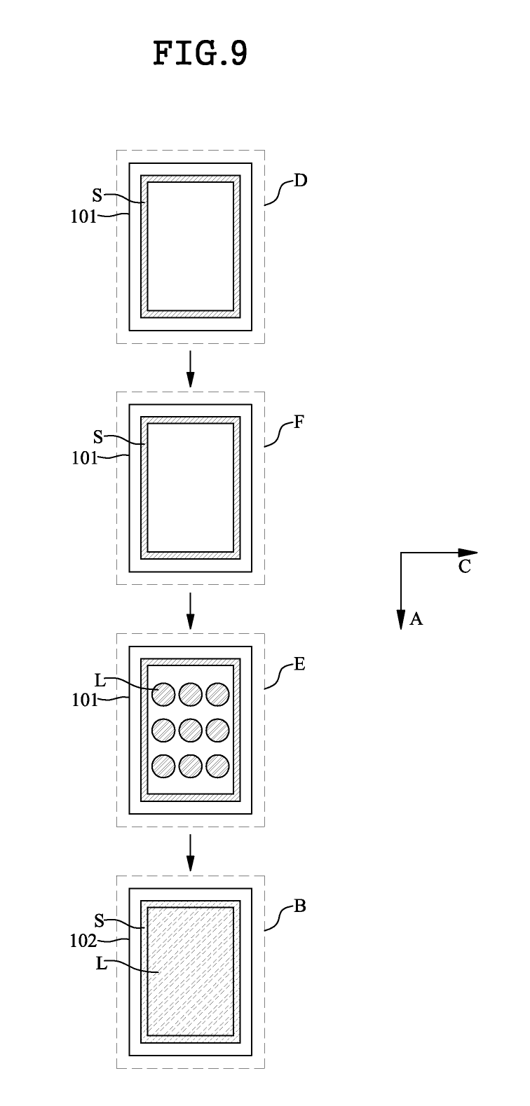

Referring to FIGS. 8 and 9, the apparatus 1 for manufacturing a liquid crystal display panel according to the present invention may further comprise a first forming unit 5 and a second forming unit 6. FIG. 8 illustrates that the apparatus 1 for manufacturing a liquid crystal display panel according to the first embodiment of the present invention includes the first forming unit 5 and the second forming unit 6. Also, the above apparatus 1 for manufacturing a liquid crystal display panel according to the second embodiment of the present invention may include the first forming unit 5 and the second forming unit 6.

The first forming unit 5 may form the sealant (S) on the first substrate 101 positioned at a first forming position (D). A process for coating the first substrate 101 with the sealant (S) may be carried out at the first forming position (D). The first forming unit 5 may form the predetermined-shaped sealant (S) on the first substrate 101, for example, the square-ring shaped sealant (S), as shown in FIG. 9. While being transferred along the X-axis and Y-axis directions, the first forming unit 5 may form the predetermined-shaped sealant (S). Herein, the X-axis direction may be the first-axis direction corresponding to the first direction (in the direction of arrow A), and the Y-axis direction may be the second-axis direction corresponding to the second direction (in the direction of arrow C), wherein the second-axis direction may be perpendicular to the first-axis direction.

The second forming unit 6 may form the liquid crystal (L) on the first substrate 101 positioned at a second forming position (E). A process for dotting the liquid crystal (L) on the first substrate 101 may be carried out at the second forming position (E). The second forming unit 6 may be positioned between the first forming position (D) and the attaching position (B). When forming the liquid crystal (L) on the first substrate 101, the second forming unit 6 may make the liquid crystal (L) positioned inside the sealant (S). The second forming unit 6 may form a plurality of liquid crystal (L) patterns at fixed intervals on the first substrate 101. For example, as shown in FIG. 9, the plurality of liquid crystal (L) patterns may be formed at fixed intervals along the X-axis direction and Y-axis direction. In FIG. 9, nine of the liquid crystal (L) patterns are formed on the first substrate 101 by the second forming unit 6, but the number of liquid crystal (L) patterns is not limited to the nine.

For example, the number of liquid crystal (L) patterns to be formed on the first substrate 101 by the second forming unit 6 may be less or more than the nine. The second forming unit 6 may form the liquid crystal (L) patterns on the first substrate 101 while being transferred in the X-axis direction and Y-axis direction.

Accordingly, the apparatus 1 for manufacturing a liquid crystal display panel according to the present invention may carry out the process for coating the sealant (S) and the process for dotting the liquid crystal (L) patterns as well as the process for attaching the flexible substrate by an In-Line method.

At this time, the transferring unit 2 may transfer the first substrate 101 in the first direction (in the direction of arrow A) so that the first substrate 101 may be sequentially positioned at the first forming position (D), the second forming position (E), and the attaching position (B). That is, the first substrate 101 may sequentially pass the first forming position (D), the second forming position (E), and the attaching position (B) by the use of transferring unit 2. In the above apparatus 1 for manufacturing a liquid crystal display panel according to the first embodiment of the present invention, the transferring unit 2 may include a supporting member 21 and a transferring member 22, wherein each member 21, 22 has a sufficiently-large size enabling the first substrate 101 to pass the first forming position (D), the second forming position (E), and the attaching position (B) in sequence. In the apparatus 1 for manufacturing a liquid crystal display panel according to the second embodiment of the present invention, the transferring unit 2 may include a first transferring member (23, See FIG. 3) and a second transferring member (24, See FIG. 3), which are provided with an interval sufficient to make the first substrate 101 pass the first forming position (D), the second forming position (E), and the attaching position (B). In the apparatus 1 for manufacturing a liquid crystal display panel according to the second embodiment of the present invention, the supporting member 21 may be formed in size corresponding to the bonding position (B), or may be formed in size corresponding to the first forming position (D), the second forming position (E), and the attaching position (B).

Referring to FIGS. 8 and 9, the apparatus 1 for manufacturing a liquid crystal display panel according to the present invention may carry out the process for forming the sealant (S) on the first substrate 101 positioned at the first forming position (D), and the process for dispensing the liquid crystal (L) on the first substrate 101 positioned at the second forming position (E), simultaneously. That is, under the condition that the transferring unit 2 stops the first substrates 101, the process for forming the sealant (S) may be applied to the first substrate 101 positioned at the first forming position (D), and the process for dispensing the liquid crystal (L) may be applied to the first substrate 101 positioned at the second forming position (E).

Referring to FIGS. 8 and 9, the apparatus 1 for manufacturing a liquid crystal display panel according to the present invention may simultaneously carry out the process for transferring the first substrate 101 from the first forming position (D) to the second forming position (E), and the process for transferring the first substrate 101 positioned at the second forming position (E) to make the first substrate 101 pass the attaching position (B). That is, when the transferring unit 2 transfers the first substrate 101 in the first direction (in the direction of arrow A), the first substrate 101 without the sealant (S) and liquid crystal (L) may be positioned at the first forming position (D); the first substrate 101 with only the sealant (S) may be positioned at the second forming position (E); and the process for attaching the first and second substrates 101 and 102 to each other may be carried out at the attaching position (B). If providing the first curing unit 4, the process for attaching the first and second substrates 101 and 102 to each other and the process for curing the sealant (S) may be carried out at the attaching position (B).

Accordingly, the apparatus 1 for manufacturing a liquid crystal display panel according to the present invention enables the manufacture of an increased number of liquid crystal display panels 100 in a short time by decreasing the time required during the process for forming the sealant (S) on the first substrate 101, the process for dispensing the liquid crystal (L) on the first substrate 101, the attaching process, and the curing process.

Referring to FIGS. 8 and 9, the apparatus 1 for manufacturing a liquid crystal display panel according to the present invention may further comprise a second curing unit 7. FIG. 8 illustrates that the apparatus 1 for manufacturing a liquid crystal display panel according to the first embodiment of the present invention includes the first forming unit 5, the second forming unit 6, and the second curing unit 7. Also, the aforementioned apparatus 1 for manufacturing a liquid crystal display panel according to the second embodiment of the present invention may include the first forming unit 5, the second forming unit 6, and the second curing unit 7.

The second curing unit 7 may cure the sealant (S) positioned at a pre-curing position (F). At the pre-curing position (F), the sealant (S) on the first substrate 101 may be pre-cured. Accordingly, as the sealant (S) is pre-cured by the second curing unit 7, it would be helpful to attach the first and second substrates 101 and 102 to each other at the attaching position (B), and also to prevent the defects from occurring by contact with the liquid crystal (L) at the second forming position (E). The second curing unit 7 may be installed between the first forming position (D) and the second forming position (E). The apparatus 1 for manufacturing a liquid crystal display panel according to the present invention may prevent the defects from occurring by the contact between the sealant (S) and the liquid crystal (L), to thereby manufacture the liquid crystal display panel 100 with the improved quality.

Referring to FIGS. 8 and 9, the second curing unit 7 may include a plurality of second light sources 71 and a second installing member 72. Each second light source emits light for pre-curing the sealant (S); and the plurality of second light sources are installed in the second installing member 72. The second light source 71 may be an LED lamp emitting UV rays. The plurality of second light sources 71 may be installed in the second installing member 72 in such a manner that the second light sources 71 may be provided at fixed intervals along the second direction (in the direction of arrow C, See FIG. 9). The second installing member 72 may be installed above the first substrate 101 positioned at the pre-curing position (F). Although not shown, the second curing unit 7 may further comprise a second connecting member. The plurality of second installing members 72 provided in the first direction (in the direction of arrow A) may be connected with the second connecting member. Accordingly, the second curing unit 7 may include the plurality of second light sources 71 entirely arranged in a matrix configuration.

In this case, the transferring unit 2 may transfer the first substrate 101 in the first direction (in the direction of arrow A) so as to make the first substrate 101 sequentially positioned at the first forming position (D), the pre-curing position (F), the second forming position (E), and the attaching position (B). That is, the first substrate 100 sequentially pass the first forming position (D), the pre-curing position (F), the second forming position (E), and the attaching position (B) while being sequentially transferred by the transferring unit 2. In the above apparatus 1 for manufacturing a liquid crystal display panel according to the first embodiment of the present invention, the transferring unit 2 may include a supporting member 21 and a transferring member 22, wherein each member 21, 22 has a sufficiently-large size enabling the first substrate 101 to pass the first forming position (D), the pre-curing position (F), the second forming position (E), and the attaching position (B) in sequence. In the apparatus 1 for manufacturing a liquid crystal display panel according to the second embodiment of the present invention, the transferring unit 2 may include a first transferring member (23, See FIG. 3) and a second transferring member (24, See FIG. 3), which are provided with an interval sufficient to make the first substrate 101 pass the first forming position (D), the pre-curing position (E), the second forming position (E), and the attaching position (B). In the apparatus 1 for manufacturing a liquid crystal display panel according to the second embodiment of the present invention, the supporting member 21 may be formed in size corresponding to the bonding position (B), or may be formed in size corresponding to the first forming position (D), the pre-curing position (F), the second forming position (E), and the attaching position (B).

Referring to FIGS. 8 and 9, the apparatus 1 for manufacturing a liquid crystal display panel according to the present invention may carry out the process for forming the sealant (S) on the first substrate 101 positioned at the first forming position (D), and the process for dispensing the liquid crystal (L) on the first substrate 101 positioned at the second forming position (E), simultaneously. That is, under the condition that the transferring unit 2 stops the first substrates 101, the process for forming the sealant (S) may be applied to the first substrate 101 positioned at the first forming position (D), and the process for dispensing the liquid crystal (L) may be applied to the first substrate 101 positioned at the second forming position (E).

Referring to FIGS. 8 and 9, the apparatus 1 for manufacturing a liquid crystal display panel according to the present invention may simultaneously carry out the process for transferring the first substrate 101 from the first forming position (D) to the second forming position (E) via the pre-curing position (F), and the process for transferring the first substrate 101 positioned at the second forming position (E) to make the first substrate pass the attaching position (B). That is, as the transferring unit 2 transfers the first substrate 101 in the first direction (in the direction of arrow A), the first substrate 101 without the sealant (S) and liquid crystal (L) may be positioned at the first forming position (D); the first substrate 101 with the sealant (S) pre-cured past the pre-curing position (F) may be positioned at the second forming position (E); and the process for attaching the first and second substrates 101 and 102 to each other may be carried out at the attaching position (B). If providing the first curing unit 4, the process for attaching the first and second substrates 101 and 102 to each other and the process for curing the sealant (S) may be carried out at the attaching position (B).

Accordingly, the apparatus 1 for manufacturing a liquid crystal display panel according to the present invention enables the manufacture of an increased number of liquid crystal display panels 100 in a short time by decreasing the time consumed during the process for forming the sealant (S) on the first substrate 101, the process for pre-curing the sealant (S), the process for dispensing the liquid crystal (L) on the first substrate 101, the attaching process, and the curing process.

Accordingly, the apparatus 1 for manufacturing a liquid crystal display panel according to the present invention is capable of manufacturing the liquid crystal panel using the flexible substrate even under atmospheric pressure conditions. Furthermore, the apparatus 1 for manufacturing a liquid crystal display panel according to the present invention reduces the cost for manufacturing the liquid crystal display panel using the flexible substrate, and also improves the quality of the liquid crystal display panel using the flexible substrate.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An apparatus for manufacturing a liquid crystal display panel comprising:
a transferring unit for transferring a first substrate in a first direction so as to make the first substrate pass an attaching position for attaching the first substrate to a second substrate; and
an attaching unit for attaching the first and second substrates passing the attaching position,
wherein the attaching unit includes first and second rotating members respectively connected one side and the other side of the second substrate so as to provide tension to the second substrate, wherein the first rotating member attaches the first and second substrates passing the attaching position.

2. The apparatus according to claim 1, further comprising a first curing unit for curing sealant between the first and second substrates,
wherein the first curing unit includes:
a plurality of first light sources emitting light to cure the sealant; and
a first installing member in which the plurality of first light sources are installed along a second direction perpendicular to the first direction.

3. The apparatus according to claim 2, wherein the first curing unit includes a first control unit for individually turning on and off the first light sources so as to apply the light to the sealant positioned at the attaching position,
wherein the first control unit selectively turns on the first light sources according to the shape of the sealant positioned at the attaching position.

4. The apparatus according to claim 1, further comprising a first curing unit for curing sealant between the first and second substrates at the attaching position,
wherein the first curing unit is installed and positioned in an installation hole of the first rotating member.

5. The apparatus according to claim 2, wherein the first curing unit comprises a first connecting member with which the first installing member is to be connected;
wherein the plurality of first installing members are connected along the first direction with the first connecting member.

6. The apparatus according to claim 1, further comprising:
a first forming unit for forming sealant on the first substrate positioned at a first forming position; and
a second forming unit for forming liquid crystal on the first substrate positioned at a second forming position,
wherein the transferring unit transfers the first substrate in the first direction so as to make the first substrate pass the first forming position, the second forming position, and the attaching position in sequence.

7. The apparatus according to claim 1, further comprising:
a first forming unit for forming sealant on the first substrate positioned at a first forming position;
a second forming unit for forming liquid crystal on the first substrate positioned at a second forming position;
a first curing unit for emitting light to cure the sealant positioned at the attaching position; and
a second curing unit for emitting light to pre-cure the sealant positioned at a pre-curing position,
wherein the transferring unit transfers the first substrate in the first direction so as to make the first substrate pass the first forming position, the pre-curing position, the second forming position, and the attaching position in sequence.

8. The apparatus according to claim 1, wherein the transferring unit comprises:
a supporting member for supporting the first substrate at the attaching position;
first and second transferring members respectively connected with one side and the other side of the first substrate so as to provide tension to the first substrate.

9. The apparatus according to claim 8, wherein the attaching unit includes a first rotating unit for rotating at least one of the first rotating member and the second rotating member so as to make the second substrate pass the attaching position.

10. The apparatus according to claim 8, wherein the transferring unit includes a second rotating unit for rotating at least one of the first transferring member and the second transferring member so as to make the first substrate transferred in the first direction.
